(19) United States
(12) Patent Application Publication
(10) Pub. No.: US 2020/0390658 A1
(43) Pub. Date: Dec. 17, 2020

(54) BABY BOTTLE HOLDER AND SLEEVE

(71) Applicant: Anjellica Matilda Williams, Orlando, FL (US)

(72) Inventor: Anjellica Matilda Williams, Orlando, FL (US)

(21) Appl. No.: 16/903,298

(22) Filed: Jun. 16, 2020

Related U.S. Application Data
(60) Provisional application No. 62/862,111, filed on Jun. 16, 2019.

(51) Int. Cl. A61J 9/06; A47G 23/02

(52) U.S. Cl. CPC A61J 9/0623; A47G 23/0241; A47G 23/0216

(57) ABSTRACT

An article holder device, is disclosed. The holder device includes a suction device, configured to create a vacuum on a fixed surface, resulting in being affixed to the fixed surface. The holder device includes a base member configured to provide leveling support to an article. The holder device includes a hollowed-out portion centrally positioned on the base member, and extending in an upward direction. The holder device includes a grip positioned within the inner periphery of the hollowed-out portion, configured to prevent the article from inadvertent slipping.

### CROSS-REFERENCE TO RELATED APPLICATIONS

This application claims the benefit of U.S. Provisional Application Ser. No. 62/862,111, titled “BABY BOTTLE HOLDER AND SLEEVE,” filed on Jun. 16, 2019. This application incorporates the entire contents of the foregoing application herein by reference.

### FIELD OF THE INVENTION

The present invention is a baby bottle holder or sleeve that prevents a liquid substance from spilling. Specifically, the present invention is a baby bottle holder or sleeve that is configured to attached to the base of the bottle to prevent the bottle from being knocked over or slipping out of a user's hand.

### BACKGROUND

In today's society caretakers and parents are constantly looking for improved processes for providing care to baby's and infants alike. Accordingly, caretakers while preparing bottles with formula, breast milk or any form of liquid formulation, run the risk of spilling the milk or liquid, ultimately wasting the child's nourishment. There are a variety of bottles that are often used of different sizes and shapes. However, breast bump compatible bottles mostly contain breast flange or shields on top, that are often too heavy and can cause the bottle to tip over. While on a flat surface, bottles run the risk of falling over because the top part of the bottles are too heavy, due to the bottom being unstable. In some instances, while transferring milk from breast milk storage bags to bottles, or transferring milk between bottles, there can be a loss of milk due to the result of spilled milk or a bottle that was inadvertently bumped.

Additionally, Young children, particularly infants and toddlers, tend to touch, move, and knock over almost anything in their possession. Part of the reason is because they are still learning their motor functions. Another reason is because they are being adventurous, explorative, and learning their abilities from a cause and effect standpoint. Naturally, parents often attempt to provide safe items, and areas for the baby to interact with and within. Often this is a tough task as baby's and infants alike naturally look to chew, touch, and play with any item within arm's reach. Accordingly, most items end up being knocked over, dropped or tossed during their interactions with these items.

This has a tendency to be quite cumbersome for parents as they look to defend, protect, and ensure that their child remains unharmed, and away from risky scenarios. Additionally, parents are often having to constantly pick things up from off the ground and return them to the baby. Additionally, often parents will need to sanitize and clean the objects before handing them back to the child in order to avoid them contacting any unnecessary germs. Babies and toddlers are also learning how to move their bodies effectively for transportation, but early on, they do not have the coordination to do this smoothly and often tip over or fall when they are trying to reach for something that is out of reach.

Circumventing many of the above described problems are especially challenging for a caregiver or for parents alike. This is especially true in reference to cups, bottles and sippy cups. These items are often mishandled, bumped, accidentally dropped, or intentionally and repeatedly thrown to the ground.

As such, there is an ongoing need for a baby bottle holder or sleeve that is configured to attached to the base of the bottle to prevent the bottle from being knocked over or slipping out of a user's, baby, or infant's hands.

### SUMMARY

In order to provide a solution to the above described issues, a baby bottle holder or sleeve that is configured to attached to the base of the bottle to prevent the bottle from being knocked over or slipping out of a user's hand is described.

In one aspect of the invention, a holder device, is disclosed. The holder device includes a suction device, configured to create a vacuum on a fixed surface, resulting in being affixed to the fixed surface. The holder device includes a base member configured to provide leveling support to an article. The holder device includes a hollowed-out portion centrally positioned on the base member, and extending in an upward direction. The holder device includes a grip positioned within the inner periphery of the hollowed-out portion, configured to prevent the article from inadvertent slipping.

In one embodiment, the suction device is configured to be flush with the outer periphery of the base member.

In one embodiment, the base member is planar and configured to be adapted to be placed on a flat fixed surface.

In one embodiment, the hollowed-out portion is a cylindrical shape.

In one embodiment, the hollowed-out portion comprises of walls configured to contact all sides of an article.

In one embodiment, the hollowed-out portion comprise of gripping devices on one or more outer periphery walls, preventing slippage from a user's hand.

In one embodiment, the article is one or more of cups, bottles and sippy cups.

In one embodiment, the suction device comprises of a suction release device, configured to release the vacuum created with the fixed surface.

In one embodiment, the suction release device is a tab, configured to release the suction.

In one embodiment, a peep hole is provided in the hollowed-out portion, configured to allow a user to see the amount of substance within the article.

In one embodiment, the amount of substance within the article is in milliliters (mL) or ounces (oz).

This Summary is provided merely for purposes of summarizing some example embodiments, so as to provide a basic understanding of some aspects of the subject matter described herein.

Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

Disclosed herein are embodiments of apparatuses, methods, and systems pertaining to a baby bottle holder or sleeve. This description includes drawings, wherein:

FIG. 1 is a side perspective view of a baby bottle holder or sleeve, in accordance with an example;

FIG. 2 is a cross sectional view of a baby bottle holder or sleeve, in accordance with an example;

FIG. 3 is a bottom view of the baby bottle holder device, in accordance with an example;

FIG. 4 is a top perspective view of a baby bottle holder or sleeve, in accordance with an example;

FIG. 5 is a perspective view of a baby bottle holder or sleeve, in accordance with an example; and

FIG. 6 is a side/bottom perspective view of a baby bottle holder or sleeve, in accordance with an example.

Elements in the figures are illustrated for simplicity and clarity and have not been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Some detailed example embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

The invention may be embodied in other specific forms without departing from the spirit of essential characteristics thereof. The present embodiments therefore to be considered in all respects as illustrative and not restrictive, the scope of the invention being indicated by the appended claims rather than by the foregoing description, and all changes which come within the meaning and range of equivalency of the claims are therefore intended to be embraced therein.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The following description is not to be taken in a limiting sense, but is made merely for the purpose of describing the general principles of exemplary embodiments. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

An article holder device, is disclosed. The holder device includes a suction device, configured to create a vacuum on a fixed surface, resulting in being affixed to the fixed surface. The holder device includes a base member configured to provide leveling support to an article. The holder device includes a hollowed-out portion centrally positioned on the base member, and extending in an upward direction. The holder device includes a grip positioned within the inner periphery of the hollowed-out portion, configured to prevent the article from inadvertent slipping.

Accordingly, the present disclosure provides, in a preferred embodiment, a baby bottle holder that suctions to surfaces. It holds the bottle in place and decreases the scenarios of spilling milk or different types of liquid. It provides stability while preventing bottles from being tipped or knocked over. The six-leaf mouth opening expands to accommodate different size bottles and also provides a snug grip to bottles. The bottle holder is attached to the base of bottles because many bottles have a heavy top and unstable based.

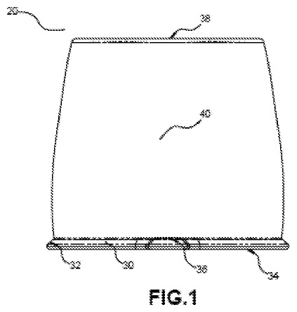

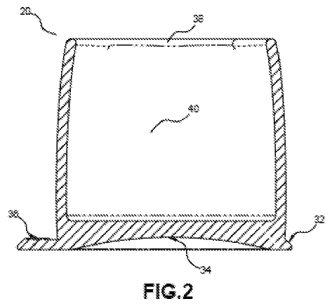

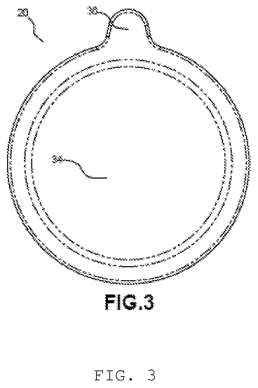

FIG. 1 is a side perspective view of a baby bottle holder or sleeve, in accordance with an example. The baby holder can be a whole bottle holder 20, that is configured to hold a baby bottle or another device configured for baby liquid consumption. The whole bottle holder 20, comprises of an inner base 30, that provides leveling support to a liquid consumption device. The inner base 30 is attached to an underneath suction device 34, configured to create a vacuum on a fixed surface, resulting in being affixed to the fixed surface. As shown in FIG. 2, in some examples, the suction device 34 is configured to be flush with the inner base 30, in order to ensure a full coverage and stability for the liquid consumption device held within the whole-body holder 20. As shown in FIG. 3, the underneath suction 34 is able to be released from a fixed surface by lifting up on a tab 36, configured to lift and release the suction 34. In essence, the suction 34 creates a vacuum on a fixed surface, around the outer edge of the base 32 which seals the surface, resulting in being affixed to the fixed surface. Releasing the tab 36, allows for a release of the vacuum, accordingly. Leading from the base 30 in an upward direction are a plurality of outside walls 40, which form a hollowed-out portion for withholding a liquid consumption device. The liquid consumption device is configured to slide or fit within the outer mouth opening 38, in order to be secured within the hollowed-out portion. The outer mouth opening 38 is configured to expand to accommodate different size bottles.

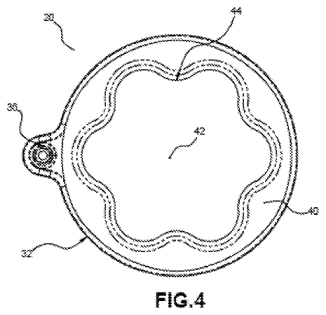

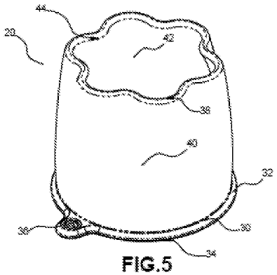

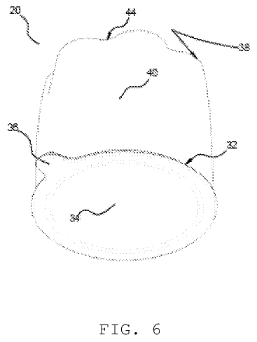

FIG. 4 is a top perspective view of a baby bottle holder or sleeve, in accordance with an example. FIG. 4 shows that the outer mouth opening 38, is constructed as a leaf mouth opening that expands to accommodate different size bottles and also provides a snug grip to bottles. Accordingly, the bottle holder is attached to the base of bottles because many bottles have a heavy top and unstable base. In reference to FIG. 5, the outside walls 40 are constructed with expandable material which allows for expansion when larger sized consumption devices are placed within the inner mouth 44 of the inside bottle holder 42. Once an article is placed within the inner mouth 44, the outside walls 40 fit snuggly around the outside of the article, providing a snug fit, tight stability, and allowing for enough stability to allows the underneath suction 34, to secure to a fixed or flat surface. As shown in FIG. 6, once the user is ready to release the underneath suction 34 via the tab 36. Accordingly, a user can reach under the tab 36, pull up, and release the vacuum that is created by the suction when originally being pressed into place on a fixed or flat surface.

Example embodiments having thus been described, it will be obvious that the same may be varied in many ways. Such variations are not to be regarded as a departure from the intended spirit and scope of example embodiments, and all such modifications as would be obvious to one skilled in the art are intended to be included within the scope of the following claims.

Although the present invention has been described in terms of various embodiments, it is not intended that the invention be limited to these embodiments. Modification within the spirit of the invention will be apparent to those skilled in the art.

What is claimed is:

1. A holder device, comprising:
a suction device, configured to create a vacuum on a fixed surface, resulting in being affixed to the fixed surface;
a base member configured to provide leveling support to an article;
a hollowed-out portion centrally positioned on the base member, and extending in an upward direction; and
a grip positioned within the inner periphery of the hollowed-out portion, configured to prevent the article from inadvertent slipping.

2. The holder device of claim 1, wherein the suction device is configured to be flush with the outer periphery of the base member.

3. The holder device of claim 1, wherein the base member is planar and configured to be adapted to be placed on a flat fixed surface.

4. The holder device of claim 1, wherein the hollowed-out portion is a cylindrical shape.

5. The holder device of claim 1, wherein the hollowed-out portion comprises of walls configured to contact all sides of an article.

6. The holder device of claim 1, wherein the hollowed-out portion comprise of gripping devices on one or more outer periphery walls, preventing slippage from a user's hand.

7. The holder device of claim 1, wherein the article is one or more of cups, bottles and sippy cups.

8. The holder device of claim 1, wherein the suction device comprises of a suction release device, configured to release the vacuum created with the fixed surface.

9. The holder device of claim 1, wherein the suction release device is a tab, configured to release the suction.

10. The holder device of claim 1, wherein a peep hole is provided in the hollowed-out portion, configured to allow a user to see the amount of substance within the article.

11. The holder device of claim 1, wherein the amount of substance within the article is in milliliters (mL) or ounces (oz).
